(19) United States
(12) Patent Application Publication
(10) Pub. No.: US 2025/0361377 A1
(43) Pub. Date: Nov. 27, 2025

(54) CATALYST COMPOSITIONS AND METHODS OF USING THE SAME

(71) Applicant: NORTH CAROLINA AGRICULTURAL AND TECHNICAL STATE UNIVERSITY, Greensboro, NC (US)

(72) Inventors: Debasish Kuila, Greensboro, NC (US); Sujoy Bepari, Greensboro, NC (US); Debarati Mukherjee, Greensboro, NC (US); Shashwata Chakraborty, Greensboro, NC (US)

(21) Appl. No.: 19/217,329

(22) Filed: May 23, 2025

Related U.S. Application Data
(60) Provisional application No. 63/651,552, filed on May 24, 2024.

(51) Int. Cl. C08J 11/16; B01J 29/40; B29B 17/04

(52) U.S. Cl. CPC C08J 11/16; B01J 29/40; B29B 17/04; B01J 2229/183; B29B 2017/0496; C08J 2323/12

(57) ABSTRACT

Methods of plastic deconstruction are provided that include conducting pyrolysis of the plastic in the presence of a catalyst. A metal-free composite support comprises mesoporous and microporous materials, which may include zeolite and silica. The catalyst results in reduction of degradation temperature of plastics and enhanced selectivity towards propene, an olefin of commercial importance.

### STATEMENT OF PRIORITY

This application claims the benefit of U.S. Provisional Application Ser. No. 63/651,552, filed May 24, 2024, the entire contents of which is incorporated by reference herein.

### GOVERNMENT SUPPORT

This invention was made with government support under DE-EE-000-9945 awarded by the Department of Energy. The government has certain rights in the invention.

### FIELD

The present invention relates to catalytic support compositions, and methods of using the same.

### BACKGROUND

Polymers are useful in countless ways due to their chemical inertness, ease of manufacturing and excellent durability. However, for several of these reasons, polymer waste has become a concern as, unlike paper, cotton and other natural materials, it does not decompose in nature easily. Plastics are mainly composed of carbon with repeating subunits. There are different types of plastics based on their application, such as the family of polyolefins, including polyethylene (PE) high-density polyethylene (HDPE), low-density polyethylene (LDPE), and polypropylene (PP). At present, ˜4.9 billion tons of plastics are piled into the natural environment and landfills. It is essential to develop a process for deconstruction of plastics and upcycling of the monomers derived from plastics.

Researchers have been using different methods for plastic deconstruction. In the case of a catalytic deconstruction process, the effect of many catalysts has been previously studied. One of the major drawbacks of this process is the necessity to obtain higher temperatures. Thus, new methods and materials are needed.

### SUMMARY

The present disclosure is based in part on the investigation of effects of catalyst on plastic pyrolysis to thereby improve efficiency of and/or decreased expense of plastic deconstruction and/or to improve processing of plastics, especially single-use plastics.

In some embodiments, a method of deconstructing plastic is provided, comprising: conducting pyrolysis of the plastic in the presence of a composite catalyst, wherein the composite catalyst comprises zeolite and silica. In some embodiments, the composite catalyst comprises microporous materials and mesoporous materials. In some embodiments, the composite catalyst comprises ZSM5/SBA15, optionally with different Si/Al molar ratios.

In some embodiments, the plastic comprises a polyolefin. In some embodiments, the plastic comprises polypropylene.

In some embodiments, the method of deconstructing plastic requires less energy than a typical thermochemical conversion of the plastic. In some embodiments, the method comprises deconstruction of polypropylene at about 270° C. to about 290° C., optionally at about 280° C. In some embodiments, the plastic comprises waste plastics.

In some embodiments, the synthesis of composite catalyst is synthesized in comprises three distinctive phases. In some embodiments, the first phase of the composite catalyst synthesis comprises preparation of ZSM-5. In some embodiments, the second phase of the composite catalyst synthesis comprises metal-impregnation on ZSM-5. In some embodiments, the third phase of composite catalyst synthesis comprises synthesis of ZSM-5/SBA-15. In some embodiments, pyrolysis of polypropylene using the ZSM-5/SBA-15 catalyst exhibits at least 72.73% selectivity towards the propene as a product.

In some embodiments, catalyst synthesis varies based on modifying the structure of ZSM-5. In some embodiments, the ZSM-5 is modified using an Si/Al ratio of 25. In some embodiments, pyrolysis onset temperature decreases to 257° C. In some embodiments, the ZSM-5 is further modified to incorporate SBA-15. In some embodiments, the pyrolysis onset temperature decreases to 240° C.

### DRAWINGS

FIG. 1 is an example setup for a pyrolysis process.

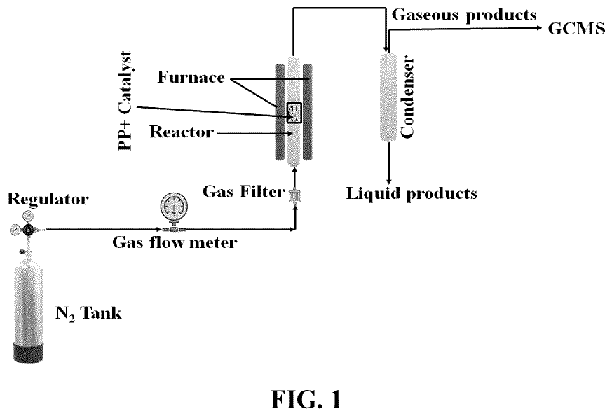

FIG. 2 is a graph showing the results of catalyst efficiency screened by thermogravimetric analysis (TGA). Zeolite Socony Mobil-5 (ZSM5)-1.2 Santa Barbara Amorphous type material (SBA)-15 resulted in reduction of degradation temperature of PP from 412 (in nascent PP) to 242° C. Hence, ZSM5-1.2 Si/Al ratio/SBA-15 was selected for further experiments.

FIG. 3 is a graph showing the X-ray diffraction pattern of synthesized ZSM-5 exhibiting a prominent peak at 22.5° corresponding to 501 crystals surfaces. The other peaks at 7.8°, 8.7°, 23.1°, 23.8° and 24.3° correspond to ZSM-5 lattice structures (JCPDS no. 37-0359).

FIG. 4 are FESEM images with tetragonal ZSM-5 particles (left) with uniform distribution of particle size ranges from 150-200 μm. In the case of ZSM-5/SBA-15 (right), formed by seeding of ZSM-5, there is a mixture of particles of two different morphologies. Uniform spherical particles with larger sizes are formed in addition to the tetragonal structured particles.

FIG. 5 is a graph showing the results of TGA for catalyst screening.

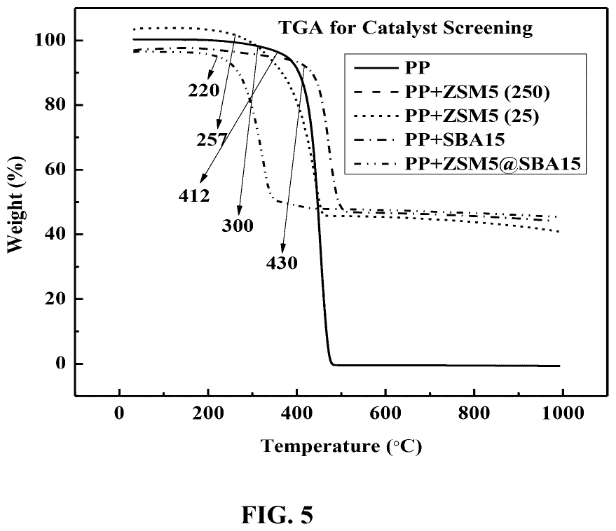

### DETAILED DESCRIPTION OF EXAMPLE EMBODIMENTS

The present invention is described more fully hereinafter with reference to the accompanying drawings, in which embodiments of the invention are shown. This invention may, however, be embodied in many different forms and should not be construed as limited to the embodiments set forth herein; rather these embodiments are provided so that this disclosure will be thorough and complete and will fully convey the scope of the invention to those skilled in the art.

As described herein, in one embodiment, microporosity (zeolite (ZSM-5)) was incorporated in mesoporous silica, Santa Barbara Amorphous-15 (SBA-15) framework and the plastic degradation temperature was reduced to about 220° C., thereby saving significant energy consumption.

The terminology used in the description of the invention herein is for the purpose of describing particular embodiments only and is not intended to be limiting of the invention. As used in the description of the invention and the appended claims, the singular forms “a,” “an” and “the” are intended to include the plural forms as well, unless the context clearly indicates otherwise.

It will be understood that, although the terms “first,” “second,” etc. may be used herein to describe various elements, these elements should not be limited by these terms. These terms are only used to distinguish one element from another. Thus, a “first” element discussed below could also be termed a “second” element without departing from the teachings of the present invention. The sequence of operations (or steps) is not limited to the order presented in the claims or figures unless specifically indicated otherwise.

Unless otherwise defined, all terms (including technical and scientific terms) used herein have the same meaning as commonly understood by one of ordinary skill in the art to which this invention belongs. It will be further understood that terms, such as those defined in commonly used dictionaries, should be interpreted as having a meaning that is consistent with their meaning in the context of the present application and relevant art and should not be interpreted in an idealized or overly formal sense unless expressly so defined herein.

All publications, patent applications, patents and other references mentioned herein are incorporated by reference in their entirety. In case of a conflict in terminology, the present specification is controlling.

Also as used herein, “and/or” refers to and encompasses any and all possible combinations of one or more of the associated listed items, as well as the lack of combinations when interpreted in the alternative (“or”).

Unless the context indicates otherwise, it is specifically intended that the various features of the invention described herein can be used in any combination. Moreover, the present invention also contemplates that in some embodiments of the invention, any feature or combination of features set forth herein can be excluded or omitted. To illustrate, if the specification states that a complex comprises components A, B and C, it is specifically intended that any of A, B or C, or a combination thereof, can be omitted and disclaimed.

As used herein, the transitional phrase “consisting essentially of” (and grammatical variants) is to be interpreted as encompassing the recited materials or steps “and those that do not materially affect the basic and novel characteristic(s)” of the claimed invention. See, In re Herz, 537 F.2d 549, 551-52, 190 U.S.P.Q. 461, 463 (CCPA 1976) (emphasis in the original); see also MPEP § 2111.03. Thus, the term “consisting essentially of” as used herein should not be interpreted as equivalent to “comprising.”

It will also be understood that, as used herein, the terms “example,” “exemplary,” and grammatical variations thereof are intended to refer to non-limiting examples and/or variant embodiments discussed herein, and are not intended to indicate preference for one or more embodiments discussed herein compared to one or more other embodiments.

The term “about,” as used herein when referring to a measurable value such as an amount or concentration and the like, is meant to encompass variations of ±10%, ±5%, ±1%, ±0.5%, or even ±0.1% of the specified value as well as the specified value. For example, “about X” where X is the measurable value, is meant to include X as well as variations of ±10%, ±5%, ±1%, ±0.5%, or even ±0.1% of X. A range provided herein for a measurable value may include any other range and/or individual value therein.

As used herein, phrases such as “between X and Y” and “between about X and Y” should be interpreted to include X and Y. As used herein, phrases such as “between about X and Y” mean “between about X and about Y” and phrases such as “from about X to Y” mean “from about X to about Y.”

Recitation of ranges of values herein are merely intended to serve as a shorthand method of referring individually to each separate value falling within the range, unless otherwise indicated herein, and each separate value is incorporated into the specification as if it were individually recited herein. For example, if the range 10 to 15 is disclosed, then 11, 12, 13, and 14 are also disclosed.

A “portion” or “fragment” of a material or component as used herein refers to less than all (e.g., less than 100%) of the material or component or of a measurable value thereof. In some embodiments, a “portion” or “fragment” of a material or component refers to about 1%, 5%, 10%, 15%, 20%, 25%, 30%, 35%, 40%, 45%, 50%, 55%, 60%, 65%, 70%, 75%, 80%, 85%, 90%, 95%, 97%, 98%, or 99% of the material or component or of a measurable value of the material or component (e.g., a portion of the length, volume, weight, sequence, etc.). In some embodiments, a “portion” or “fragment” of a particle or a plurality of particles refers to about 1%, 5%, 10%, 15%, 20%, 25%, 30%, 35%, 40%, 45%, 50%, 55%, 60%, 65%, 70%, 75%, 80%, 85%, 90%, 95%, 97%, 98%, or 99% of the particle or of the plurality of particles, respectively.

The term “comprise,” “comprises” and “comprising” as used herein, specify the presence of the stated features, integers, steps, operations, elements, and/or components, but do not preclude the presence or addition of one or more other features, integers, steps, operations, elements, components, and/or groups thereof.

As used herein, the terms “increase,” “increased,” and “increasing” (and grammatical variations thereof) describe an elevation of at least about 5%, 10%, 15%, 20%, 25%, 30%, 35%, 40%, 45%, 50%, 55%, 60%, 65%, 70%, 75%, 80%, 85%, 90%, 95%, 100%, 150%, 200%, 300%, 400%, 500% or more such as compared to another measurable property or quantity (e.g., a control value).

As used herein, the terms “reduce,” “reduced,” “reducing,” “reduction,” “diminish,” and “decrease” (and grammatical variations thereof), describe, for example, a decrease of at least about 5%, 10%, 15%, 20%, 25%, 30%, 35%, 40%, 45%, 50%, 55%, 60%, 65%, 70%, 75%, 80%, 85%, 90%, 95%, 97%, 98%, 99%, or 100% such as compared to another measurable property or quantity (e.g., a control value). In some embodiments, the reduction can result in no or essentially no (i.e., an insignificant amount, e.g., less than about 10% or even 5%) detectable activity or amount.

Non-thermal plasma treatment as used herein can include low-pressure glow and radiofrequency (RF), microwave discharges, dielectric barrier discharges (DBD) and/or laser produced plasma.

Micropore structure as used herein comprises a pore size (e.g., diameter or internal width) of less than 2 nm, for example, between about 0.1 nm and less than 2 nm. In some embodiments, a micropore has an average value of between about 0.20 nanometers and 1.0 nanometers, between about 0.40 nanometers and 0.6 nanometers, or between about 0.45 nm and 0.55 nm.

Mesopore structure as used herein comprises a pore size (e.g., diameter or internal width) of between about 2 nm and 50 nm, for example, between about 3 nm and 40 nm. In some embodiments, a mesopore has an average value of between about 3 nanometers and 30 nanometers, between about 4 nanometers and 25 nanometers, or between about 5 nm and 15 nm.

Provided according to embodiments of the present invention is a composition comprising a plurality of particles (e.g., microparticles and/or nanoparticles). A composition of the present invention may comprise two or more particles that are the same and/or that are different from each other. In some embodiments, the plurality of particles comprises two or more particles that comprise at least one material (e.g., a zeolite) that is the same and/or that have the same properties and/or same material(s) present. In some embodiments, the plurality of particles comprises two or more particles that comprise at least one material (e.g., a mesoporous silica) that is different and/or that have a different property. In some embodiments, the mixture of particles comprises two different morphologies. In some embodiments, the compositions comprise a combination of microporous materials and mesoporous materials. In some embodiments, a plurality of particles present in a composition of the present invention are solid particles. A plurality of particles comprised in a composition of the present invention may be amorphous and/or crystalline and/or may comprise a material (e.g., an excipient (e.g., a salt), that is amorphous and/or crystalline.

In some embodiments, a particle of the present invention comprises a crystalline material such as a small molecule (e.g., a salt) that is present in a particle may be crystalline. A plurality of particles of the present invention may be uniform in size or may be polydisperse. In some embodiments, a composition (e.g., a solution) comprising one or more particle types is aqueous. In some embodiments, at least a portion of a plurality of particles have a size that is within about ±5%, 10%, 15%, 20%, 25%, 50%, 75%, 100%, 150%, 200%, 300%, 400%, 500%, or more of the average particle size. In some embodiments, the particles are processed such that particles of one material are dissolved. In some embodiments, upon dissolution of one material, a formation of an overgrowth material is formed (e.g., ZSM-5 (NaₙAlₙSi₉₆₋ₙO₁₉₂·16H₂O (0<n<27))-on-Santa Barbara Amorphous-15 (SBA-15)), thereby forming a catalyst support. In some embodiments, the method comprises synthesis of a material comprising ZSM-5/SBA-15 catalyst support in-situ via a hydrothermal technique. In some embodiments, the material is formed by seeding of ZSM, forming a mixture of particles of two different morphologies, e.g., mesoporous and microporous. In some embodiments, spherical particles with larger size are formed in addition to tetragonal structured particles. In some embodiments, a zeolite with a Si/Al ratio of between 1 and 2 is used, for example, between 1.0 and 1.5, or about 1.2.

In some embodiments, the composition comprises a catalyst support devoid of one or more embedded metals in the support composition. In some embodiment, the support composition and the catalyst utilized in the method are the same material. In some embodiments, the catalyst support composition comprises a primary structure characteristic of MFI-type zeolites.

In some embodiments, methods using the composition are provided. In some embodiments, the method comprises pretreating a plastic material with plasma followed by catalytic pyrolysis. In some embodiments, the methods thereby produce olefins (C₂-C₄) from the plastic material. In some embodiments, the methods provide treatment of plastics that improve the product distribution towards olefins, benzene, toluene and/or xylene relative to conventional plastic deconstruction involving pyrolysis. In some embodiments, the methods provide treatment of plastics that upcycle into propene, C₃-C₆ olefins with lower energy input (e.g., at lower temperature).

In some embodiments, a method of deconstructing plastic comprises treating the plastic with non-thermal plasma; and conducting pyrolysis of the plastic in the presence of a catalyst. In some embodiments, the method comprises non-thermal plasma treatment followed successively by catalytic pyrolysis. In some embodiments, the non-thermal plasma assisted plastic deconstruction comprises dielectric barrier discharge plasma. In some embodiments, the non-thermal plasma treatment is performed on a composite support comprising mesoporous and microporous materials

In some embodiments, the composite support comprises zeolite and silica. In some embodiments, the catalyst comprises both microporous and mesoporous materials.

In some embodiments, the catalyst comprises zeolite and silica. The zeolite can comprise ZSM-5 and the silica can comprise SBA-15. In some embodiments, the composite material and the catalyst are the same material.

In some embodiments, the catalyst synthesis is done in three distinctive phases: 1) Preparing ZSM-5, 2) Metal-Impregnation on ZSM-5, and 3) Synthesis of ZSM-5/SBA-15. In some embodiments, the precursors of silicon and aluminum comprise Tetraethyl Orthosilicate (TEOS) and Aluminum Nitrate Nonahydrate (ANN), respectively. In some embodiments, the Si/Al ratio is between about 25 and 250, or any range therein. In some embodiments, the molar ratio of Al₂O₃ and SiO₂ is between 0.12:60 and 1.2:60, or any range therein. In some embodiments, the plastic comprises a polyolefin, for example, polypropylene, polyethylene and/or polystyrene. In some embodiments, the plastic material comprises waste plastics.

In some embodiments, the method of deconstructing plastic requires less energy than a thermochemical conversion of plastic. In some embodiments, the method of deconstructing plastic can be performed at a lower temperature than conventional plasma treatment. In some embodiments, the method of deconstructing plastic improves the product distribution towards olefins, benzene, toluene, xylene and/or C₂-C₄ products. C₂-C₄ products include compounds that include 2, 3, or 4 carbon atoms such as C₂H₆, C₃H₈, C₄H₁₀, and the like.

In some embodiments, the method comprises deconstruction of the plastic at about 270° C. to about 290° C., preferably about 280° C.

In some embodiments, treating with non-thermal plasma is performed at a voltage between 20 and 40 kV. In some embodiments, treating with non-thermal plasma is performed at a frequency between 330 Hz to 800 Hz. In some embodiments, treating with non-thermal plasma and conducting pyrolysis is performed approximately simultaneously. In some embodiments, treating with non-thermal plasma is performed prior to conducting pyrolysis of the plastic.

Having described the present invention, the same will be explained in greater detail in the following examples, which are included herein for illustration purposes only, and which are not intended to be limiting to the invention.

### EXAMPLES

As described in this example, a novel way of upcycling plastics such as polypropylene and polyethylene was investigated by pyrolysis in the presence of Zeolite Socony Mobil-5 (ZSM-5) and ZSM-5/Santa Barbara Amorphous-15 (SBA-15) catalysts. The composite of ZSM-5/SBA-15 performed much better than ZSM-5 or SBA-15 alone to decompose polyethylene (PE) and polypropylene (PP) at a lower temperature with higher conversion and higher selectivity to the production of useful chemicals.

### Investigating Effects of Catalysts on Plastic Pyrolysis

ZSM-5 is in general known to be an excellent catalyst support material for its high silica and alumina content. It was invented by Mobil in 1972 and used for isomerization of petroleum products. In the present research of pyrolysis, ZSM-5 acts both as a good catalyst and support material. By varying the Si/Al ratio and pore size, the number of acidic sites and the size of the intermediates from plastics after primary cracking could be optimized. There are many combinations of ZSM-5 and different metals as catalysts that can be used based on the types of plastics. The results are varied based on catalytic efficiency. Fe, Co, Cr, Ce supported with ZSM-5 were synthesized with Si/Al ratio 25 and 250. Furthermore, to facilitate the catalysts with hierarchical structure, ZSM-5 was wet-impregnated with SBA-15 (ZSM-5/SBA-15). The physiochemical properties of the catalysts were characterized by different techniques, such as XRD, SEM, FTIR, TGA-DSC. The catalyst was then run through the fixed-bed reactor with polypropylene at 1:1 weight ratio.

### Investigating Effects of Process Parameters on Plastic Pyrolysis

The products formed during the pyrolysis process are analyzed in Gas Chromatography Mass Spectroscopy (GC-MS). The GC-MS analysis, accompanied by TCD (Thermal Conductivity Detector) to help quantifying the products (gas and liquid) produced during the pyrolysis. The effect of different process parameters are studied based on product selectivity and conversion.

### Synthesis of Catalysts

The catalyst synthesis is done in three distinctive phases. They are: 1. Preparation of ZSM-5, 2. Metal-Impregnation on ZSM-5, and 3. Synthesis of ZSM-5/SBA-15.

### Preparation of ZSM-5

Given the ease of synthesis and the versatility of the ZSM-5, any number of combinations is possible. For this research, two main batches of ZSM-5 were prepared by varying the Silicon to Aluminum Ratio. The Si/Al ratio is 25 and 250 respectively. For the synthesis, the method has been followed as reported by Taghizadeh et al. [30]. For the precursors of silicon and aluminum, Tetraethyl Orthosilicate (TEOS) and Aluminum Nitrate Nonahydrate (ANN) have been used respectively. Tetrapropyl-Ammonium Hydroxide (TPAOH) Solution has been used as the templating agent. For obtaining a Si/Al ratio of 25, the molar ratio of Al₂O₃ and SiO₂ must be 1.2:60. For Si/Al ratio of 250, the Al₂O₃:SiO₂ molar ratio is kept at 0.12:60.

First, TPAOH is added with deionized water and stirred for 30 minutes. Then Aluminum precursor, ANN is added, and the solution is again left for stirring for another 30 minutes. After making sure that all ANN dissolved into the solution TEOS is added dropwise and stirred for 3-4 hours. Parafilm is used to cover the solution every time when left for stirring to prevent any contamination. The solution is then hydrothermally treated at 170° C. for 100 hours (4 days and 4 hours). After 100 hours, the hydrothermal is taken out and allowed to cool overnight. The solution, which is mostly basic, is washed with DI water, stirred at 50-60° C., followed by centrifuging at 4000 rpm for 30 minutes. These washing, stirring, and centrifuging are repeated until neutral pH is obtained. The solution is then poured on a petri dish and dried at 120° C. The dried sample is then collected in porcelain evaporating dish which is then put inside a muffle furnace to calcine the sample at 550° C. for 6 hours.

### Metal-Impregnation on ZSM-5

Metals introduce additional active sites that can aid in cracking long-chain hydrocarbons, dehydrogenation, hydrogenation, aromatization, and coke suppression. They are incorporated on the zeolite surface via Incipient Wetness Impregnation (IWI) where there is controlled metal loading based on zeolite pore volume. Transition metals such as Ni promotes Cracking, hydrogenation, dehydrogenation resulting in gas and light oil production, Co results in Cracking and aromatization, and Fe causes Selective cracking resulting in syngas generation.

### Synthesis of ZSM-5/SBA-15

The mixture of ZSM-5 and SBA-15 is prepared by hydrothermal technique following the method described by Wang et al. with some modifications. The ZSM-5, previously synthesized, is mixed with Pluronic Acid, 2M HCl and TEOS, followed by hydrothermal treatment at 100° C. for 24 hours. After the hydrothermal treatment, the sample is washed and dried to get ZSM-5/SBA-15 the composite. The drying process is done at 120° C. for 24 hours. Finally, the dried sample is calcined at 550° C. for 6 hours.

Two types of ZSM-5/SBA-15 catalysts containing ZSM-5 with Si/Al molar ratio of 25 and 250 were prepared to study the effects of varying Si/Al ratio. Hence, while Al content was 0.12 mole in one catalyst, the other had ten times enhanced alumina content of 1.2. While the synthesis protocol for the composite preparation remained same for both the catalysts, the difference lies in maintaining different ANN and TEOS ratio, which is calculated based on the Si/Al molar ratios. Table 1 represents different catalysts synthesized for this purpose.

TABLE 1
Synthesized Catalysts

| Ratio of | | |
|---|---|---|
| SiO₂:Al₂O₃ | | SBA-15 |
| Si/Al (250) | ZSM-5, Al 0.12 | ZSM-5/SBA-15 (Al-0.12) |
| (Al-0.12) | | |
| Si/Al (25) | ZSM-5, Al 1.2 | ZSM-5/SBA-15 (Al-1.2) |
| (Al-1.2) | | |

### Pyrolysis of Plastic

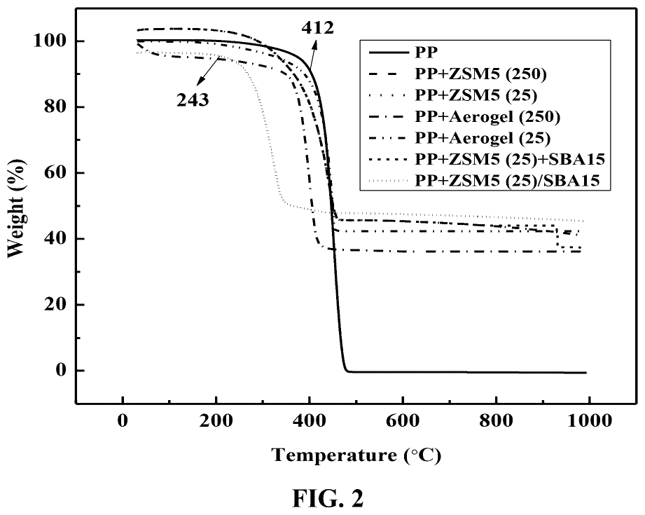

Different catalysts were synthesized by modifying the structure of ZSM-5. The efficiency of the catalysts was screened by TGA analysis as shown in FIG. 2. The primary target of catalytic pyrolysis of plastics is to achieve a low degradation temperature. This was performed by mixing the catalysts with 300 μm size Polypropylene at a 1:1 ratio. Polypropylene (PP) degradation begins at approximately 300° C. when using ZSM-5 with a Si/Al ratio of 250. This onset temperature decreases to 257° C. when the Si/Al ratio is reduced to 25, making the latter composition more favorable for PP degradation studies. When SBA-15 is incorporated into the ZSM-5 (Si/Al=25) structure, the degradation temperature of PP further drops to 240° C., significantly lower than that observed with either pure ZSM-5 or SBA-15 alone. For comparison, PP degradation over SBA-15 alone begins at a much higher temperature of 430° C. Hence, ZSM5-5/SBA-15 (25) was selected for further experiments. It was concluded that Si/Al ratio was found to have an effect on plastic degradation.

### Characterization of ZSM/SBA-15

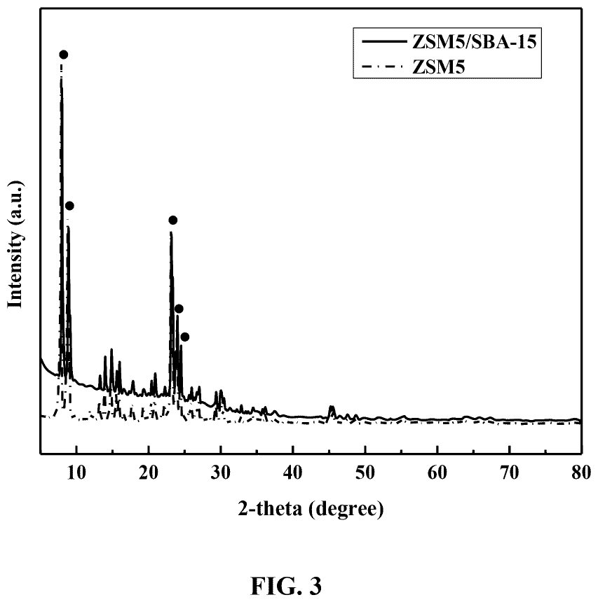

The synthesized ZSM-5 exhibits a prominent peak at 22.5° corresponding to 501 crystal surface (FIG. 3). The other peaks at 7.8°, 8.7°, 23.1°, 23.8° and 24.3° correspond to ZSM-5 lattice structures (JCPDS no. 37-0359). This implies that the samples likely exhibit the primary structure characteristic of MFI-type zeolites. See, doi: 10.1007/s42452-019-1036-9; and doi: 10.1016/j.mex.2018.03.004. There is no significant change and retention in crystallinity of the zeolite structure upon SBA-15 incorporation.

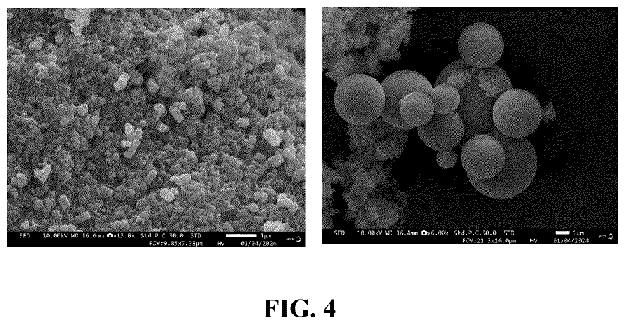

FESEM images conclude tetragonal ZSM-5 particles with uniform distribution (FIG. 4). The particle size ranges from 150-200 μm. However, in the case of ZSM-5/SBA-15, formed by seeding of ZSM, there is a mixture of particles of two different morphologies. Uniform spherical particles with larger size are formed in addition to the tetragonal structured particles. The larger particles might be aggregates of the smaller ones. During the second step of crystallization, it appears that SBA-15 particles dissolved, potentially leading to the formation of ZSM-5-on-SBA-15 overgrowth material through the procedure currently employed. This is in agreement to the structural changes that occurred upon incorporation of zeolite in ZSM-5 framework as reported by Chen et al., 2003; doi: 10.1246/cl.2003.726.

### Pyrolysis of PP

TABLE 3
Pyrolysis Products

| | | | | |
|---|---|---|---|---|
| | | Pristine | | Pristine PP + |
| Pristine | Pristine | PP + ZSM5/ | Pristine | Physically mixed |
| PP | PP + ZSM5 | SBA15 | PP + SBA15 | ZSM5 + SBA15 |
| only | 1:1 (Ratio) | 1:1 (Ratio) | 1:1 (Ratio) | 1:1 (Ratio) |

Selectivity (%)

| | | | | | |
|---|---|---|---|---|---|
| 1-Pentene | — | 0.11 | 0.14 | — | 0.16 |
| Pentane | 3.68 | 2.91 | 2.20 | — | 1.45 |
| trans-2- | — | 0.07 | 0.08 | — | — |
| Pentene | | | | | |
| cis-2- | — | 0.24 | 0.30 | — | — |
| Pentene | | | | | |
| H₂ | 0.37 | 0.09 | 0.05 | 0.59 | 0.12 |
| Butane | 0.69 | 5.43 | 3.91 | — | 4.49 |
| Ethylene | — | 0.29 | 0.24 | — | 0.53 |
| 1,3 Butadiene | — | 0.21 | 0.14 | — | 0.14 |
| Ethane | 0.67 | 0.19 | 0.21 | 0.08 | 0.31 |
| Propene | — | 63.78 | 72.73 | — | 59.02 |
| Propane | 22.39 | 18.6 | 13.27 | 2.19 | 19.98 |
| Methane | 71.55 | 2.82 | 2.22 | 86.75 | 4.45 |
| CO | 0.56 | 4.52 | 3.62 | 6.36 | 8.12 |
| CO₂ | 0.088 | 0.132 | 0.11 | 4.01 | 0.72 |
| Propadiene | — | 0.26 | 0.30 | — | 0.16 |
| Butene | — | 0.40 | 0.46 | — | 0.34 |
| Conversion | 19 | 52.55 | 91.5 | 5.3 | 83.5 |
| (%) | | | | | |

Table 3 shows the pyrolysis products under varying conditions (reaction temperature 400° C. and N₂ flow rate 1.5 ml/min) including with and without catalysts. It's evident that introducing a catalyst into the pyrolysis process enhances the product yield. Notably, the ZSM5/SBA15 composite catalyst yields the greatest diversity of products (mainly propene) among those examined [32],

### REFERENCES

1 Geyer, R., Jambeck, J. R., and Law, K. L.: ‘Production, use, and fate of all plastics ever made’, Sci Adv, 2017, 3, (7), pp. e1700782
2 Zhang, Z., Gora-Marek, K., Watson, J. S., Tian, J., Ryder, M. R., Tarach, K. A., López-Pérez, L., Martínez-Triguero, J., and Melián-Cabrera, I.: ‘Recovering waste plastics using shape-selective nano-scale reactors as catalysts’, Nature Sustainability, 2019, 2, (1), pp. 39-42
3 Gupta, A. K., and Lilley, D. G.: ‘Thermal Destruction of Wastes and Plastics’: ‘Plastics and the Environment’ (2003), pp. 629-696
4 Law, K. L.: ‘Plastics in the Marine Environment’, Annual Review of Marine Science, 2017, 9, (1), pp. 205-229
5 Karl Küpfmüller, W. M., Albrecht Reibiger: ‘Theoretische Elektrotechnik Eine Einführung’ (Springer Vieweg Berlin, 2013, 19 edn. 2013)
6 Hannah Ritchie, V.S.a.M.R.: ‘Plastic Pollution’, in Editor (Ed.)\hat{ }(Eds.): ‘Book Plastic Pollution’ (2023, edn.), pp.
7 Thiounn, T., and Smith, R.C.: ‘Advances and approaches for chemical recycling of plastic waste’, Journal of Polymer Science, 2020, 58, (10), pp. 1347-1364
8 Anuar Sharuddin, S. D., Abnisa, F., Wan Daud, W. M. A., and Aroua, M.K.: ‘A review on pyrolysis of plastic wastes’, Energy Conversion and Management, 2016, 115, pp. 308-326
9 Jia, X., Qin, C., Friedberger, T., Guan, Z., and Huang, Z.: ‘Efficient and selective degradation of polyethylenes into liquid fuels and waxes under mild conditions’, Science Advances, 2016, 2, (6), pp. e1501591
10 Dogu, O., Pelucchi, M., Van de Vijver, R., Van Steenberge, P. H. M., D'Hooge, D.R., Cuoci, A., Mehl, M., Frassoldati, A., Faravelli, T., and Van Geem, K. M.: ‘The chemistry of chemical recycling of solid plastic waste via pyrolysis and gasification: State-of-the-art, challenges, and future directions’, Progress in Energy and Combustion Science, 2021, 84, pp. 100901
11 Supriyanto, Ylitervo, P., and Richards, T.: ‘Gaseous products from primary reactions of fast plastic pyrolysis’, Journal of Analytical and Applied Pyrolysis, 2021, 158, pp. 105248
12 Dai, L., Zhou, N., Li, H., Wang, Y., Liu, Y., Cobb, K., Cheng, Y., Lei, H., Chen, P., and Ruan, R.: ‘Catalytic fast pyrolysis of low density polyethylene into naphtha with high selectivity by dual-catalyst tandem catalysis’, Sci Total Environ, 2021, 771, pp. 144995
13 Singh, B. K., Kim, Y., Kwon, S., and Na, K.: ‘Synthesis of Mesoporous Zeolites and Their Opportunities in Heterogeneous Catalysis’, Catalysts, 2021, 11, (12)
14 Neves, I.C., Botelho, G., Machado, A. V., and Rebelo, P.: ‘The effect of acidity behaviour of Y zeolites on the catalytic degradation of polyethylene’, European Polymer Journal, 2006, 42, (7), pp. 1541-1547
15 Duan, J., Chen, W., Wang, C., Wang, L., Liu, Z., Yi, X., Fang, W., Wang, H., Wei, H., Xu, S., Yang, Y., Yang, Q., Bao, Z., Zhang, Z., Ren, Q., Zhou, H., Qin, X., Zheng, A., and Xiao, F.-S.: ‘Coking-Resistant Polyethylene Upcycling Modulated by Zeolite Micropore Diffusion’, Journal of the American Chemical Society, 2022, 144, (31), pp. 14269-14277
16 Meng, X., Dai, M., Zhou, Y., Wu, J., Li, P., Yang, B., Chu, R., Li, X., Li, W., Wu, G., and Wang, C.: ‘Efficient-selective-catalytic aromatization of methanol over Zn-HZSM-5/SAPO-34: Action mechanism of Zn’, Microporous and Mesoporous Materials, 2023, 356
17 Bi, C., Wang, X., You, Q., Liu, B., Li, Z., Zhang, J., Hao, Q., Sun, M., Chen, H., and Ma, X.: ‘Catalytic upgrading of coal pyrolysis volatiles by Ga-substituted mesoporous ZSM-5’, Fuel, 2020, 267
18 Marcilla, A., Beltrán, M. I., and Navarro, R.: ‘Thermal and catalytic pyrolysis of polyethylene over HZSM5 and HUSY zeolites in a batch reactor under dynamic conditions’, Applied Catalysis B: Environmental, 2009, 86, (1-2), pp. 78-86
19 Han, Y., Yu, J., Chen, T., Liu, X., and Sun, L.: ‘Study on catalytic pyrolysis mechanism of natural rubber (NR) over Zn-modified ZSM5 catalysts’, Journal of the Energy Institute, 2021, 94, pp. 210-221
20 Munir, D., Amer, H., Aslam, R., Bououdina, M., and Usman, M. R.: ‘Composite zeolite beta catalysts for catalytic hydrocracking of plastic waste to liquid fuels’, Materials for Renewable and Sustainable Energy, 2020, 9, (2), pp. 9
21 Ratnasamy, P.: ‘Crystal symmetry and shape selectivity in ZSM-5 zeolites’, Catalysis Today, 1988, 3, (5), pp. 531-535
22 Singh, S., Kumar, R., Setiabudi, H.D., Nanda, S., and Vo, D.-V.N.: ‘Advanced synthesis strategies of mesoporous SBA-15 supported catalysts for catalytic reforming applications: A state-of-the-art review’, Applied Catalysis A: General, 2018, 559, pp. 57-74
23 Aydemir, B., Asli Sezgi, N., and Doğu, T.: ‘Synthesis of TPA impregnated SBA-15 catalysts and their performance in polyethylene degradation reaction’, AIChE Journal, 2011, 58, (8), pp. 2466-2472
24 Narksri, P., Angnanon, S., Guntasub, J., Wijitrattanatri, K., Kingputtapong, S., Phumpradit, S., and Hinchiranan, N.: ‘Production of alternative liquid fuels from catalytic hydrocracking of plastics over Ni/SBA-15 catalyst’, Materials Today: Proceedings, 2022, 57, pp. 1040-1047
25 Kostov, K.G., Nishime, T.M.C., Hein, L. R. O., and Toth, A.: ‘Study of polypropylene surface modification by air dielectric barrier discharge operated at two different frequencies’, Surface and Coatings Technology, 2013, 234, pp. 60-66
26 Mercado-Cabrera, A., Jaramillo-Sierra, B., López-Callejas, R., Valencia-Alvarado, R., de la Piedad-Beneitez, A., Peña-Eguiluz, R., Barocio-Delgado, S., Muñoz-Castro, A., and Rodríguez-Méndez, B.: ‘Surface modification of polypropylene fiber for hydrophilicity enhancement aided by DBD plasma’, Progress in Organic Coatings, 2013, 76, (12), pp. 1858-1862
27 Palaskar, S.S.: ‘Adhesion properties of polypropylene fabric treated with atmospheric pressure plasma and coated with polyurethane: Studies on ageing process’, International Journal of Adhesion and Adhesives, 2023, 125, pp. 103428
28 Paisoonsin, S., Pornsunthorntawee, O., and Rujiravanit, R.: ‘Preparation and characterization of ZnO-deposited DBD plasma-treated PP packaging film with antibacterial activities’, Applied Surface Science, 2013, 273, pp. 824-835
29 Geyter, N. D., and Morent, R.: ‘Cold plasma surface modification of biodegradable polymer biomaterials’, in Editor (Ed.)\hat{ }(Eds.): ‘Book Cold plasma surface modification of biodegradable polymer biomaterials’ (2014, edn.), pp.
30 Hassanpour, S., Taghizadeh, M., and Yaripour, F.: ‘Preparation, Characterization, and Activity Evaluation of H-ZSM-5 Catalysts in Vapor-Phase Methanol Dehydration to Dimethyl Ether’, Industrial & Engineering Chemistry Research, 2010, 49, (9), pp. 4063-4069
31 Li, R., Xue, T., Li, Z., and Wang, Q.: ‘Hierarchical structure ZSM-5/SBA-15 composite with improved hydrophobicity for adsorption-desorption behavior of toluene’, Chemical Engineering Journal, 2020, 392, pp. 124861
32 Chakraborty, S., Mukherjee, D., Bepari, S., and Kuila, D.: ‘Effect of metal-free mesoporous silica incorporated ZSM-5 composite on thermos-catalytic pyrolysis of polypropylene’, Journal of Environmental Chemical Engineering, 2025, 13, pp. 115681

We claim:

1. A method of deconstructing plastic comprising:
conducting pyrolysis of the plastic in the presence of a composite catalyst, wherein the composite catalyst comprises zeolite and silica.

2. The method of claim 1, wherein the composite catalyst comprises microporous materials and mesoporous materials.

3. The method of claim 2, wherein the composite catalyst comprises ZSM5/SBA15.

4. The method of claim 1, wherein the plastic comprises a polyolefin.

5. The method of claim 1, wherein the plastic comprises polypropylene.

6. The method of claim 1, wherein the method of deconstructing plastic requires less energy than a typical thermochemical conversion of the plastic.

7. The method of claim 5, wherein the method comprises deconstruction of polypropylene at about 270° C. to about 290° C., optionally at about 280° C.

8. The method of claim 1, wherein the plastic comprises waste plastics.

9. The method of claim 1, wherein the composite catalyst is synthesized in three distinctive phases.

10. The method of claim 9, wherein the first phase of the composite catalyst synthesis comprises preparation of ZSM-5.

11. The method of claim 9, wherein the second phase of the composite catalyst synthesis comprises metal-impregnation on ZSM-5.

12. The method of claim 9, wherein the third phase of composite catalyst synthesis comprises synthesis of ZSM-5/SBA-15.

13. The method of claim 5, wherein pyrolysis of polypropylene using the ZSM-5/SBA-15 catalyst exhibits at least 72.73% selectivity towards the propene as a product.

14. The method of claim 10, wherein catalyst synthesis varies based on modifying the structure of ZSM-5.

15. The method of claim 14, wherein the ZSM-5 is modified using an Si/Al ratio of 25.

16. The method of claim 15, wherein pyrolysis onset temperature decreases to 257° C.

17. The method of claim 15, wherein the ZSM-5 is further modified to incorporate SBA-15.

18. The method of claim 17, wherein the pyrolysis onset temperature decreases to 240° C.
